(19) United States
(12) Patent Application Publication
(10) Pub. No.: US 2011/0276366 A1
(43) Pub. Date: Nov. 10, 2011

(54) METHOD AND SYSTEM FOR EVALUATING A MOBILE DEVICE MANUFACTURER PERFORMANCE

(76) Inventors: Jean-Philippe GOYET, Montreal (CA); Eric MÉLIN, Montreal (CA); Alexandre HAYON, Montreal (CA)

(21) Appl. No.: 13/104,491

(22) Filed: May 10, 2011

Related U.S. Application Data
(60) Provisional application No. 61/332,849, filed on May 10, 2010.

(51) Int. Cl. G06Q 10/00

(52) U.S. Cl. 705/7.29

(57) ABSTRACT

The present relates to a method and a system for evaluating a mobile device manufacturer performance. The method and system update a database of subscriber records representative of mobile devices used on a mobile operator network, and extract information from the subscriber records in the database in relation to a selected mobile device manufacturer and a selected time period. The method and system further process said information to calculate a metric representative of a performance of said selected mobile device manufacturer over said selected time period, wherein each subscriber record comprises at least a unique identifier of a subscriber, a mobile device manufacturer identifier, and a timestamp.

### BRIEF DESCRIPTION OF THE DRAWINGS

In the appended drawings:

FIG. 1 illustrates a system for evaluating a mobile device manufacturer performance, according to a non-restrictive illustrative embodiment;

FIG. 2 illustrates a method for evaluating a mobile device manufacturer performance, according to a non-restrictive illustrative embodiment;

FIG. 3 illustrates a computation of a manufacturer loyalty index, according to a non-restrictive illustrative embodiment;

FIG. 4 illustrates a computation of a manufacturer attraction index, according to a non-restrictive illustrative embodiment;

FIG. 5 illustrates an alternative computation of a manufacturer loyalty index, according to a non-restrictive illustrative embodiment;

FIG. 6 illustrates an alternative computation of a manufacturer attraction index, according to a non-restrictive illustrative embodiment; and

FIG. 7 illustrates a report displaying metrics representative of a mobile device manufacturer performance, according to a non-restrictive illustrative embodiment.

### DETAILED DESCRIPTION

The competition between manufacturers of mobile devices is becoming increasingly intense and complex. The development of mobile data services and applications, and the demand for mobile devices with advanced capabilities like smartphones, is steadily increasing the penetration rate and the market size for mobile devices. In this context, more and more manufacturers are joining the competition for a share of this market.

Consequently, there is a growing demand for key metrics allowing the evaluation and comparison of the performance of various competing manufacturers of mobile devices. For instance, a mobile Operator is strongly interested in tracking the performance in terms of market share of each manufacturer of mobile devices. Following almost in real time the performance of each manufacturer enables the mobile Operator to adapt its mobile devices portfolio offering, focusing on manufacturers with a good performance and avoiding manufacturers with a poor performance. Offering a portfolio of mobile devices which better fits the subscribers' needs and expectations is a means to differentiate from other mobile Operators.

However, having accurate and comprehensive data on the performance of the manufacturers of mobile devices (for example in terms of market share), with a good flexibility on the time period to take into account and the frequency of the evaluation, is currently difficult for mobile Operators.

One way to proceed is to make surveys on a panel of the subscribers of the mobile operators, asking them if they changed their mobile device over a predefined period of time; and in case they changed, if they selected a mobile device from the same or a different manufacturer. This method is limited in terms of accuracy, due to the fact that the panel is only a small fraction of the subscriber base of the mobile Operator. This method is also limited in terms of flexibility: using a panel imposes limitations on the period of time to consider and on the frequency of the evaluations of the performance of the manufacturers.

Another way to proceed is to extract data from the existing information system of a mobile Operator, to evaluate the performance of the various manufacturers. However, the existing information system was not designed for this specific purpose. Thus, the data may be incomplete (for example, the grey market is not taken into account and only the mobile devices purchased from the mobile Operator are taken into account—mobile devices acquired via a different channel cannot be easily tracked by the information system of the mobile Operator), may necessitate intensive pre-processing to allow the evaluation of the performance of a manufacturer on a selected period of time, and may lack in terms of granularity and accuracy as regards the period of time over which the performance is evaluated.

Thus, there is a need for overcoming the above discussed limitations concerning the availability of accurate and exhaustive data, and also the flexibility in the selection of the period of time to consider, which prevent the generation of a reliable evaluation of a mobile device manufacturer performance. An object of the present method and system is therefore to evaluate a mobile device manufacturer performance.

In a general embodiment, the present method is adapted for evaluating a mobile device manufacturer performance. For doing so, the method updates a database of subscriber records representative of mobile devices used on a mobile operator network. Then, extracts information from the subscriber records in the database in relation to a selected mobile device manufacturer and a selected time period. The method then processes the information to calculate a metric representative of a performance of the selected mobile device manufacturer over the selected time period. Each subscriber record comprises at least a unique identifier of a subscriber, a mobile device manufacturer identifier, and a timestamp.

In another general embodiment, the present system is adapted for evaluating a mobile device manufacturer performance. For doing so, the system comprises a database for storing subscriber records representative of mobile devices used on a mobile operator network. The system also comprises a processing unit, for updating the database, for extracting information from the subscriber records in the database in relation to a selected mobile device manufacturer and a selected time period, and for processing the information to calculate a metric representative of a performance of the selected mobile device manufacturer over the selected time period. Each subscriber record comprises at least a unique identifier of a subscriber, a mobile device manufacturer identifier, and a timestamp.

In one specific aspect of the present method and system, the metric representative of the performance of the selected mobile device manufacturer over the selected time period is a manufacturer loyalty index.

In another specific aspect of the present method and system, the metric representative of the performance of the selected mobile device manufacturer over the selected time period is a manufacturer attraction index.

In still another specific aspect of the present method and system, each subscriber has a status of either returning subscriber or new subscriber; and the metric representative of the performance of the selected mobile device manufacturer over the selected time period is a manufacturer loyalty index, using the status of the subscribers for the calculation.

In still another specific aspect of the present method and system, each subscriber has a status of either returning subscriber or new subscriber; and the metric representative of the performance of the selected mobile device manufacturer over the selected time period is a manufacturer attraction index, using the status of the subscribers for the calculation.

In still another specific aspect of the present method and system, each subscriber has a status of either returning subscriber or new subscriber; and the metric representative of the performance of the selected mobile device manufacturer over the selected time period is a model attraction index, using the status of the subscribers for the calculation.

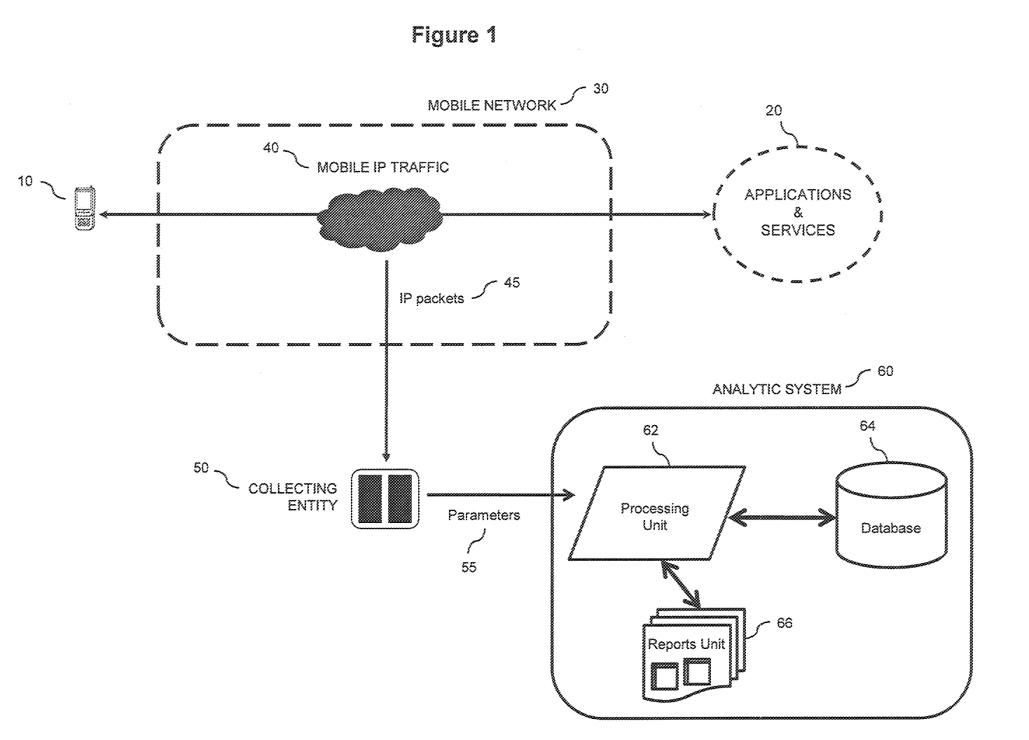

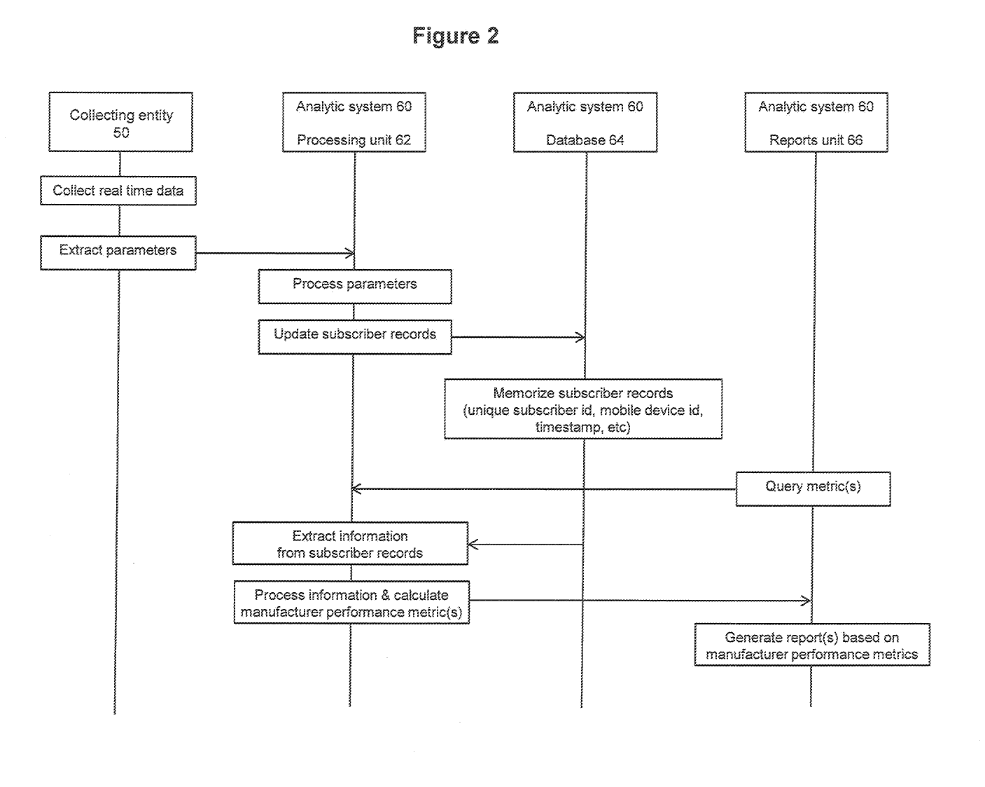

Now referring concurrently to FIGS. 1 and 2, a method and system for evaluating a mobile device manufacturer performance will be described.

A mobile network 30 is represented on FIG. 1. It allows mobile devices 10 to access IP based applications and services 20, via the mobile network 30. For this purpose, mobile IP traffic 40 is generated between the mobile devices 10 and the infrastructure supporting the IP based applications and services 20.

The present method and system may be applied to any type of mobile network, including without limitation: Universal Mobile Telecommunication System (UMTS) network, Long Term Evolution (LTE) network, Code Division Multiple Access (CDMA) network, or Worldwide Interoperability for Microwave Access (WIMAX) network.

A collecting entity 50 is used to capture in real time IP packets 45 from the mobile IP traffic 40. The collecting entity 50 extracts relevant parameters 55 from the captured IP packets 45 and transmits these parameters to an analytic system 60, for further analysis.

In a specific embodiment, the collecting entity 50 relies on a Deep Packet Inspection (DPI) engine for extracting the relevant parameters 55 from the IP packets 45. A DPI engine is a technology well known in the art. It has the capability to identify specific IP sessions, related to a specific mobile device 10 and/or related to a specific application, and to extract relevant parameters. For this purpose, the DPI engine inspects each IP packet 45 according to the protocol layers defined in the Open System Interconnection (OSI) model. The protocol layers usually taken into consideration are the network, transport, and application layers.

The analytic system 60 is composed of three sub-entities: a processing unit 62, a database 64 and a reports unit 66.

The first functionality of the processing unit 62 is to analyze the parameters 55 received from the collecting entity 50, and to update the database 64 if necessary. An update is necessary each time the processing unit 62 detects that a specific subscriber has changed the mobile device 10 that he is using on the mobile network 30. For this purpose, the collected parameters 55 (representative of the IP sessions performed by the mobile devices 10) on the mobile network 30 include at least the following information: a timestamp indicative of when the IP session took place, an identifier of the model of mobile device 10 being used (including at least the manufacturer identification), and a unique identifier of the subscriber who owns this mobile device 10.

The database 64 contains subscriber records representative of the history of the mobile devices owned by each subscriber. A subscriber record includes the unique identifier of the subscriber, and a historic list of identifiers of the mobile devices owned by this subscriber over time, along with timestamps to determine the duration of ownership for each specific mobile device. The identifier of each mobile device may simply consist in the model and the manufacturer of the mobile device. This information is sufficient for the purpose of the present method and system. However, a unique identifier of each mobile device (including the identification of the model and the manufacturer) may be provided by the collecting entity 50 among the parameters 55, and recorded in the database 64. For instance, in the case of an UMTS or LTE mobile network, the International Mobile Equipment Identity (IMEI) is a unique identifier of a mobile device, which is captured by the collecting entity 50. The manufacturer and the model of the mobile device are derived from the IMEI.

The processing unit 62 operates as follows. Upon reception of the parameters 55 from the collecting entity 50, the parameters 55 representative of a specific IP session performed by a specific mobile device 10 are analyzed, and the unique identifier of the associated mobile subscriber is extracted. The database 64 is queried with this unique identifier of the mobile subscriber, and the corresponding subscriber record is extracted from the database 64. The mobile device currently owned by the subscriber, as recorded in the subscriber record, is compared to the mobile device currently used, as recorded in the parameters 55 representative of the IP session. If it is different, the subscriber record is updated with the mobile device currently used. This mobile device becomes the mobile device currently owned, and the subscriber record is updated in the database 64. The timestamp associated to the IP session is used to indicate the end of usage of the previously owned mobile device, and to indicate the beginning of usage of the newly owned mobile device. The subscriber record is updated in the database 64 with the timestamp information.

The information related to the mobile devices in the subscriber records may take different forms, based on the type of parameters 55 transmitted by the collecting entity 50. However, this information shall at least allow the identification of the manufacturer of each mobile device recorded in the subscriber records. The identification of each specific model of mobile device allows a better granularity, and allows additional metrics to be calculated, as will be detailed later in the description.

For exemplary purposes only, we will now detail the parameters 55 extracted by the collecting entity 50, analyzed by the processing unit 62 and stored in the database 64, in the context of a Universal Mobile Telecommunication System (UMTS) network, but it should be noted that the present method and system are not limited to UMTS networks.

The collecting entity 50 collects mobile IP data traffic from a Gn interface of a Gateway GPRS Support Node (GGSN). There is typically one collecting entity 50 per GGSN present in the mobile network 30, and the extracted parameters 55 for each collecting entity 50 are aggregated at a single centralized analytic system 60.

Each mobile device 10 engaged in an IP session is allocated a unique GPRS Tunneling Protocol (GTP) tunnel. The following parameters 55 are extracted by the collecting entity 50 from the IP packets 45 corresponding to a specific GTP tunnel. A timestamp of the creation of the GTP tunnel: it corresponds to the beginning of the IP session established by a specific mobile device 10. A unique identifier of the mobile subscriber associated to the mobile device 10: either the International Mobile Subscriber Identity (IMSI) or the Mobile Subscriber Integrated Services Digital Network Number (MSISDN) is extracted from the GTP tunnel signaling traffic (generally referred to as the GTP control plane), to uniquely identify the related mobile subscriber. An identifier of the mobile device 10: the IMEI is also extracted from the GTP tunnel signaling traffic. The IMEI is a unique identifier of a mobile device, and contains the model and the manufacturer of the mobile device.

The processing unit 62 analyzes the transmitted parameters 55, which include: a timestamp, the IMSI or MSISDN, and the IMEI. As already mentioned, the subscriber records of the database 64 are updated when necessary. A subscriber record includes the IMSI or MSISDN as the unique identifier of a mobile subscriber. Each mobile device owned by the mobile subscriber is represented by its IMEI, or alternatively by the model and/or manufacturer of the mobile device. Timestamps are used to indicate the beginning and end of ownership of each mobile device.

As an alternative, the same type of information (timestamp, IMSI, MSISDN, IMEI) may be collected on a Gi interface of the GGSN by the collecting entity 50. For this purpose, the Remote Authentication Dial In User Service (RADIUS) protocol used on the Gi interface is analyzed, and the corresponding parameters extracted.

The aforementioned operations, described in the context of a UMTS mobile network, may be generalized to any type of mobile network. The collected parameters 55 may differ, but would include timestamps, unique identifiers of the mobile subscribers, and identifiers of the mobile devices (at least model and manufacturer).

The second functionality of the processing unit 62 is to extract information from the database 64, and to process this information to generate metrics representative of the performance of a mobile device manufacturer. These metrics are transmitted to the reports unit 66, in order to be presented in the form of reports to the end users of the analytic system 60.

In one embodiment, the reports unit 66 transmits requests for metrics to the processing unit 62. A request for a metric includes: a specific type of metric (several different metrics may be generated to characterize the performance of the mobile device manufacturers), a specific time period and a specific manufacturer (and optionally one/several specific model(s) of mobile device from the portfolio of the specific manufacturer). The processing unit 62 extracts the related information from the database 64, computes the metric based on the extracted information, and returns the metric to the reports unit 66.

Having the specific time period and the specific manufacturer for which the metric is calculated, the processing unit 62 generates requests for the database 64, to extract the related information from the subscriber records. The related information generally consists in the exhaustive list of subscriber records for which a mobile device corresponding to the specific manufacturer was owned during the specific time period. These subscriber records are further processed in a way specific to each particular metric to be calculated.

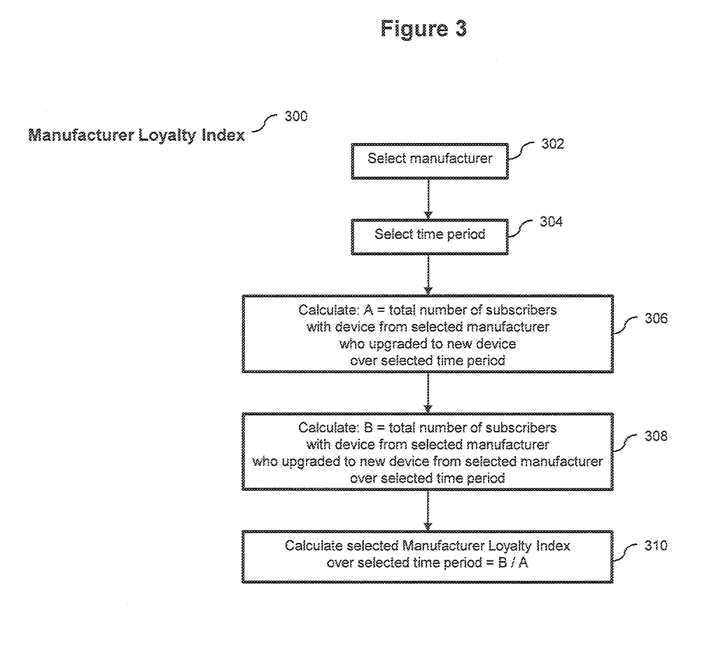

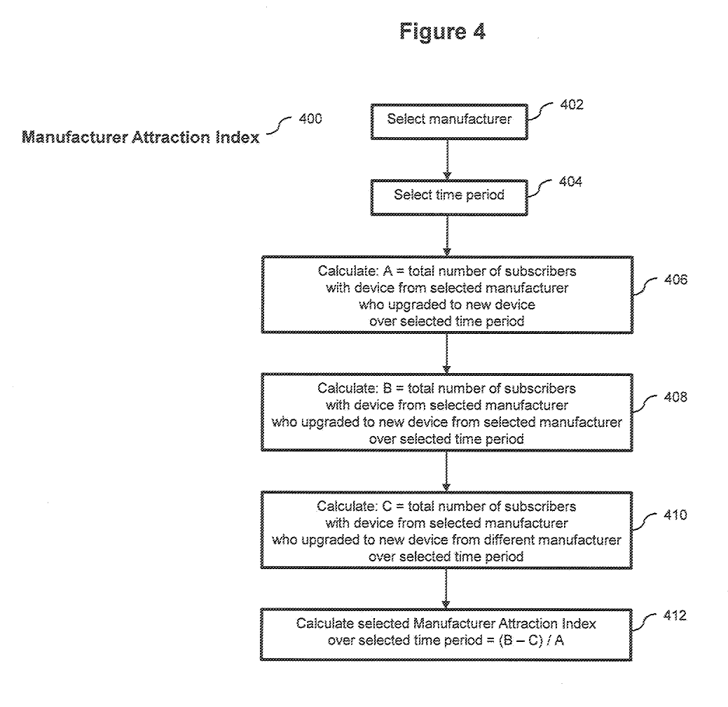

FIG. 3 and FIG. 4 will further illustrate two metrics representative of a mobile device manufacturer performance, which are calculated by the processing unit 62.

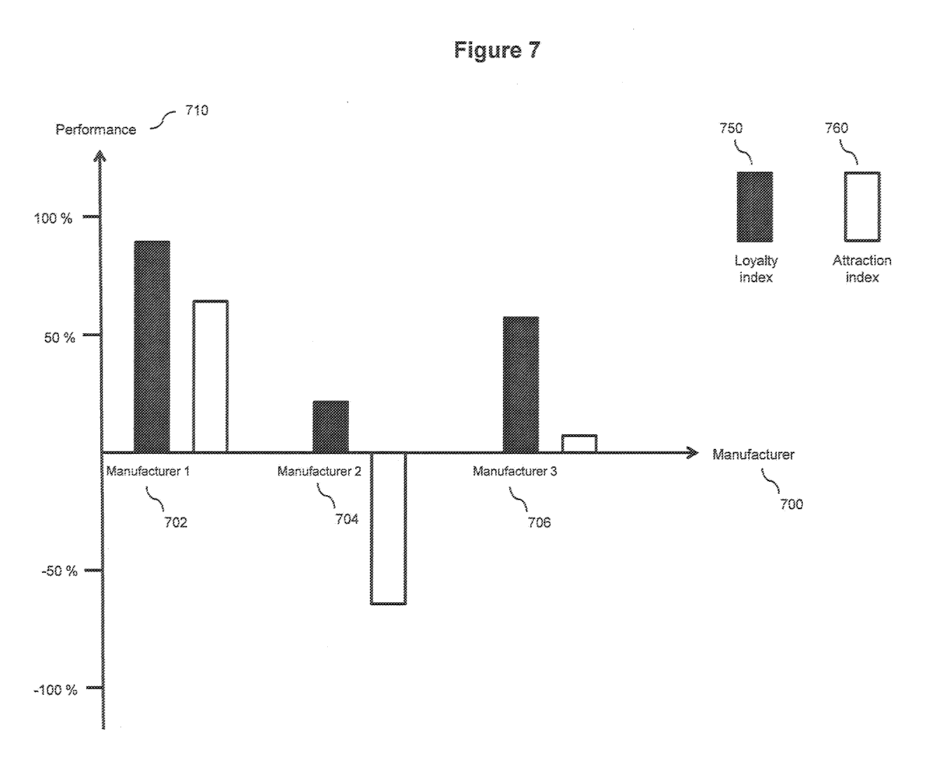

The reports unit 66 generates reports based on the combination of several calculated metrics, which are presented to the end users via a graphical user interface, using the most appropriate chart format (column, line, pie, bar . . . ) for each specific report. The reports allow, for example, the presentation of several metrics for a specific manufacturer and a specific time period; the presentation of the evolution of one or several metrics over a time period (for instance, the metrics are calculated each month over a one year period); and the comparison of one or several metrics for several manufacturers for a specific time period. FIG. 7 will further illustrate an example of such a report.

Now referring concurrently to FIGS. 1 and 3, a computation of a manufacturer loyalty index will be described.

The manufacturer loyalty index 300 is an illustration of a metric computed by the processing unit 62. A mobile device manufacturer 302 and a time period 304 are selected by an end user of the reports unit 66, and a request is transmitted to the processing unit 62 to calculate the associated manufacturer loyalty index 300. If several metrics are available, to characterize the manufacturer loyalty index, the request also includes the list of metric(s) to be calculated.

The processing unit 62 queries the database 64 to calculate the value A 306: the total number of subscribers who owned a mobile device from the selected mobile device manufacturer 302 over the selected time period 304, and who upgraded to a new mobile device.

The processing unit 62 queries the database 64 to calculate the value B 308: the total number of subscribers who owned a mobile device from the selected mobile device manufacturer 302 over the selected time period 304, and who upgraded to a new mobile device from the selected mobile device manufacturer 302.

As previously mentioned, the subscriber records stored in the database 64 contain the history of the ownership of mobile devices for each unique subscriber of the mobile operator, allowing the computation of values A and B.

Then, the manufacturer loyalty index (for the selected mobile device manufacturer 302 over the selected time period 304) is computed 310 by dividing value B by value A.

Now referring concurrently to FIGS. 1 and 4, a computation of a manufacturer attraction index will be described.

The manufacturer attraction index 400 is an illustration of a metric computed by the processing unit 62. A mobile device manufacturer 402 and a time period 404 are selected by an end user of the reports unit 66, and a request is transmitted to the processing unit 62 to calculate the associated manufacturer attraction index 400. If several metrics are available, to characterize the manufacturer loyalty index, the request also includes the list of metric(s) to be calculated.

The processing unit 62 queries the database 64 to calculate the value A 406: the total number of subscribers who owned a mobile device from the selected mobile device manufacturer 402 over the selected time period 404, and who upgraded to a new mobile device.

The processing unit 62 queries the database 64 to calculate the value B 408: the total number of subscribers who owned a mobile device from the selected mobile device manufacturer 402 over the selected time period 404, and who upgraded to a new mobile device from the selected mobile device manufacturer 402.

The processing unit 62 queries the database 64 to calculate the value C 410: the total number of subscribers who owned a mobile device from the selected mobile device manufacturer 402 over the selected time period 404, and who upgraded to a new mobile device from a mobile device manufacturer different from the selected mobile device manufacturer 402.

As previously mentioned, the subscriber records stored in the database 64 contain the history of the ownership of mobile devices for each unique subscriber of the mobile operator, allowing the computation of values A, B and C.

Then, the manufacturer attraction index (for the selected mobile manufacturer 402 over the selected time period 404) is computed 412 by dividing (value B minus value C) by value A.

FIGS. 3 and 4 illustrate two examples of metrics which are computed, to characterize the performance of a mobile device manufacturer. Other metrics may be computed as well, based on the historic information memorized in the subscriber records of the database 64.

Additionally, the metrics may also be calculated for a specific model or group of models, within the portfolio of models of mobile devices manufactured by a selected mobile device manufacturer. In this case, as already mentioned previously, the subscriber records in the database 64 of FIG. 1 shall include identification information related to the models of mobile devices, in addition to the identification of the manufacturers of the mobile devices.

In this case, the manufacturer loyalty index for the selected model(s) is: [the total number of subscribers who owned a mobile device of the selected model(s) from the selected mobile manufacturer over the selected time period and who upgraded to a new mobile device from the selected mobile device manufacturer] divided by [the total number of subscribers who owned a mobile device of the selected model(s) from the selected mobile device manufacturer over the selected time period, and who upgraded to a new mobile device]. This index may be referred to as a manufacturer model(s) loyalty index.

In this case, the manufacturer attraction index for the selected model(s) is: [the total number of subscribers who owned a mobile device of the selected model(s) from the selected mobile device manufacturer over the selected time period and who upgraded to a new mobile device from the selected mobile device manufacturer] minus [the total number of subscribers who owned a mobile device of the selected model(s) from the selected mobile device manufacturer over the selected time period, and who upgraded to a new mobile device from a mobile device manufacturer different from the selected mobile device manufacturer] divided by [the total number of subscribers who owned a mobile device of the selected model(s) from the selected mobile device manufacturer over the selected time period, and who upgraded to a new mobile device]. This index may be referred to as a manufacturer model(s) attraction index.

Referring to FIG. 1, in order to compute these enhanced indexes, the information stored in the subscriber records of the database 64 shall include the model of each mobile device owned by a specific subscriber. This information is usually present in the parameters 55 gathered by the collecting entity 50. For example, in the case of a UMTS network, the IMEI of each mobile device 10 engaged in a mobile IP session is collected by the collecting entity 50. The IMEI contains an identifier of the mobile device manufacturer, and an identifier of the specific model within the manufacturer portfolio, for the mobile device 10 considered. Thus, this information (the specific model of mobile device) is transmitted to the processing unit 62 and stored in the subscriber records of the database 64.

Then, for the calculation of the indexes, the queries addressed by the processing unit 62 to the database 64 refer not only to a selected mobile device manufacturer, but also to one (several) selected model(s) which were owned by subscribers over a selected time period.

In an additional embodiment of the present method and system, the notion of subscribers of the mobile Operator, operating the mobile operator network, may be further refined as follows. The subscribers are divided in two categories. The returning subscribers are subscribers who have been subscribers of the mobile Operator for a pre-defined duration. And the new subscribers are subscribers who have recently become subscribers of the mobile Operator. Thus, after the pre-defined duration has elapsed, a new subscriber becomes a returning subscriber.

Since the various indexes defined in the present method and system are calculated over a specific time period, the status of particular subscribers may change from new to returning during this specific time period. How these particular subscribers are handled is dependent on a specific implementation of the calculation of the various indexes. For instance, it may be implemented as follows: a subscriber which has/acquires the status new during the specific time period never transitions to the status returning during this specific time period.

In this embodiment of the present method and system, the subscriber records memorized in the database 64 of FIG. 1 include this notion of new and returning subscribers. For instance, when a new subscriber is detected on the mobile network 30 of FIG. 1, a timestamp of the time and date of its detection is memorized in the subscriber record associated to this subscriber, and its status is new. After an amount of time corresponding to the timestamp of the time and date of its detection plus the pre-defined duration, the status of the subscriber is returning.

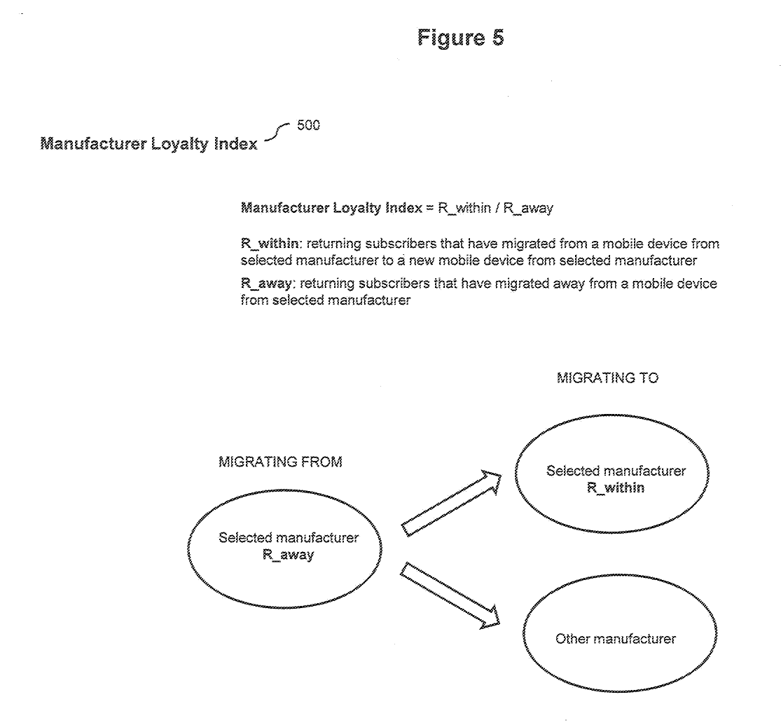

In this case, the manufacturer loyalty index for the selected mobile device manufacturer over the selected time period is: [the total number of returning subscribers who owned a mobile device from the selected mobile device manufacturer over the selected time period and who migrated to a new mobile device from the selected mobile device manufacturer (R_within)] divided by [the total number of returning subscribers who owned a mobile device from the selected mobile device manufacturer over the selected time period, and who migrated to any new mobile device (R_away)]. FIG. 5 illustrates an example of the calculation of this manufacturer loyalty index.

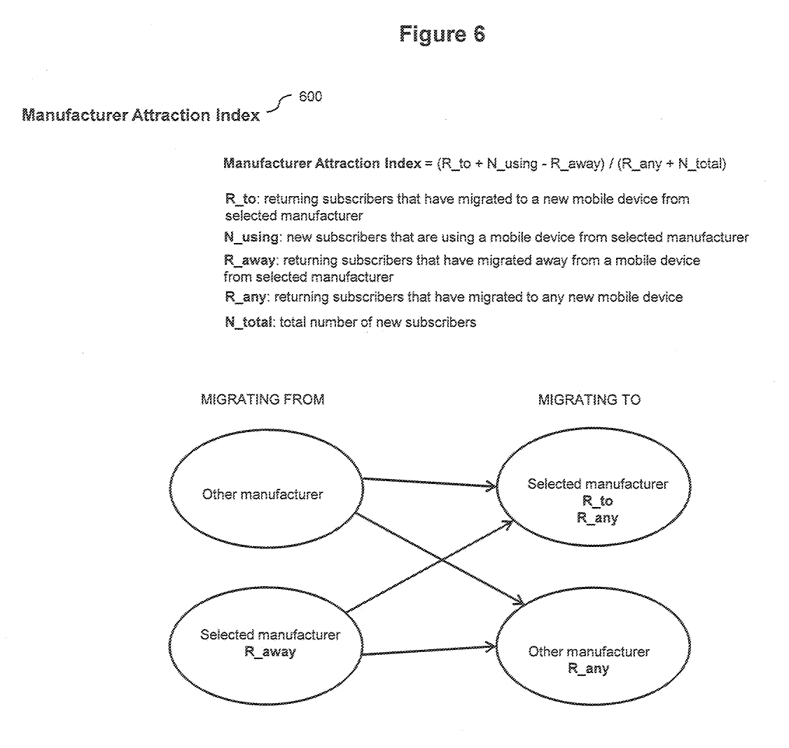

In this case, the manufacturer attraction index for the selected mobile device manufacturer over the selected time period is: [[the total number of returning subscribers who migrated to a new mobile device from the selected mobile device manufacturer over the selected time period (R_to)] plus [the total number of new subscribers who own a mobile device from the selected mobile device manufacturer over the selected time period (N_using)] minus [the total number of returning subscribers who owned a mobile device from the selected mobile device manufacturer over the selected time period, and who migrated to any new mobile device (R_away)]] divided by [[the total number of returning subscribers who migrated to any new mobile device over the selected time period (R_any)] plus [the total number of new subscribers over the selected time period (N_total)]]. FIG. 6 illustrates the calculation of this manufacturer attraction index.

As previously mentioned, the attraction index may also be calculated for a specific model within the portfolio of models of mobile devices manufactured by a selected mobile device manufacturer. In this case, the model attraction index for the selected model of mobile device (from the selected mobile device manufacturer) over the selected time period is: [[the total number of returning subscribers who migrated to a new mobile device of the selected model over the selected time period] plus [the total number of new subscribers who own a mobile device of the selected model over the selected time period] minus [the total number of returning subscribers who owned a mobile device of the selected model over the selected time period, and who migrated to any new mobile device]] divided by [[the total number of returning subscribers who migrated to any new mobile device over the selected time period] plus [the total number of new subscribers over the selected time period]].

In order to allow the calculation of the model attraction index, each subscriber record stored in the database 64 of FIG. 1 comprises not only a mobile device manufacturer identifier, but also a mobile device model identifier. For instance, in the case of a mobile network (30 in FIG. 1) of type UMTS, the IMEI of the mobile device (10 in FIG. 1) is collected by the collecting entity (50 in FIG. 1). The mobile device manufacturer identifier and the mobile device model identifier are extracted from the IMEI by the processing unit (62 in FIG. 1), and memorized in the proper subscriber record of the database (64 in FIG. 1).

Alternatively, the loyalty index and the attraction index may also be calculated for a specific category of mobile devices. Such categories include (for example): feature phones, smart phones, tablets, nomadic computers, dongles, etc. In this case, the category loyalty index for the selected category over the selected time period is: [the total number of returning subscribers who owned a mobile device from the selected category over the selected time period and who transitioned to a new mobile device from the selected category] divided by [the total number of returning subscribers who owned a mobile device from the selected category over the selected time period, and who transitioned to any new mobile device]. This particular type of index is not related to a specific mobile device manufacturer, but to a category at large (across manufacturers).

And in this case, the category attraction index for the selected category over the selected time period is: [[the total number of returning subscribers who migrated to a new mobile device from the selected category over the selected time period] plus [the total number of new subscribers who own a mobile device from the selected category over the selected time period] minus [the total number of returning subscribers who owned a mobile device from the selected category over the selected time period, and who migrated to any new mobile device]] divided by [[the total number of returning subscribers who migrated to any new mobile over the selected time period] plus [the total number of new subscribers over the selected time period]].

Now referring to 7, a report displaying metrics representative of a mobile device manufacturer performance will be described.

As already mentioned, the reports unit 66 of FIG. 1 sends requests to the processing unit 62, to calculate metrics. A specific metric is characterized by its type (e.g. the loyalty index or the attraction index), the mobile device manufacturer for which it is computed, and the time period considered for the computation.

Multiple metrics are usually combined in a single report, to perform comparisons between several manufacturers and/or over several time periods. FIG. 7 is an illustration of such a report.

The two metrics illustrated in FIGS. 3 and 4 are represented in the report of FIG. 7: the loyalty index 750 and the attraction index 760. The horizontal axis represents several manufacturers 700 for which the indexes have been calculated. The vertical axis represents the performance 710 of the manufacturer, as indicated by the value of each index. By definition, the loyalty index has a value between 0 and 100 percent; while the attraction index has a value between −100 and 100 percent.

For illustration purposes, FIG. 7 represents a first manufacturer 702 with excellent loyalty and attraction indexes; a second manufacturer 704 with poor loyalty and attraction indexes; and a third manufacturer 706 with a good loyalty index and a limited attraction index.

Another type of report (not represented in FIG. 7) consists in following the evolution of an index over time. For instance, the loyalty and attraction indexes are calculated over time periods of one month, and their evolution month by month over a one year period is represented in a report. Additionally, the indexes of several manufacturers may be displayed in the same report for comparison purposes.

Although the present method and system have been described in the foregoing specification by means of several non-restrictive illustrative embodiments, these illustrative embodiments can be modified at will without departing from the scope of the following claims.

What is claimed is:

1. A method for evaluating a mobile device manufacturer performance, the method comprising:
updating a database of subscriber records representative of mobile devices used on a mobile operator network;
extracting information from the subscriber records in the database in relation to a selected mobile device manufacturer and a selected time period; and
processing said information to calculate a metric representative of a performance of said selected mobile device manufacturer over said selected time period;
wherein each subscriber record comprises at least a unique identifier of a subscriber, a mobile device manufacturer identifier, and a timestamp.

2. The method of claim 1, wherein the metric representative of the performance of the mobile device manufacturer is a manufacturer loyalty index.

3. The method of claim 2, wherein the manufacturer loyalty index consists in:
calculating value A as the total number of subscribers, who owned a mobile device from the selected mobile device manufacturer over the selected time period, and who upgraded to a new mobile device;
calculating value B as the total number of subscribers who owned a mobile device from the selected mobile device manufacturer over the selected time period, and who upgraded to a new mobile device from the selected mobile device manufacturer; and
dividing value B by value A.

4. The method of claim 3, wherein the total number of subscribers who owned a mobile device from the selected mobile device manufacturer is calculated for a selected model or group of models within the portfolio of models of mobile devices manufactured by the selected mobile device manufacturer.

5. The method of claim 4, wherein each subscriber record comprises a mobile device model identifier.

6. The method of claim 1, wherein the metric representative of the performance of the mobile device manufacturer is a manufacturer attraction index.

7. The method of claim 6, wherein the manufacturer attraction index consists in:
calculating value A as the total number of subscribers who owned a mobile device from the selected mobile device manufacturer over the selected time period, and who upgraded to a new mobile device;
calculating value B as the total number of subscribers who owned a mobile device from the selected mobile device manufacturer over the selected time period, and who upgraded to a new mobile device from the selected mobile device manufacturer;
calculating value C as the total number of subscribers who owned a mobile device from the selected mobile device manufacturer over the selected time period, and who upgraded to a new mobile device from a mobile device manufacturer different from the selected mobile device manufacturer; and
dividing (value B minus value C) by value A.

8. The method of claim 7, wherein the total number of subscribers who owned a mobile device from the selected mobile device manufacturer is calculated for a selected model or group of models within the portfolio of models of mobile devices manufactured by the selected mobile device manufacturer.

9. The method of claim 8, wherein each subscriber record comprises a mobile device model identifier.

10. The method of claim 1, wherein each subscriber has a status of either returning subscriber or new subscriber.

11. The method of claim 10, wherein the metric representative of the performance of the mobile device manufacturer is a manufacturer loyalty index and consists in:
calculating value R_within as the total number of returning subscribers who owned a mobile device from the selected mobile device manufacturer over the selected time period, and who migrated to a new mobile device from the selected mobile device manufacturer;
calculating value R_away as the total number of returning subscribers who owned a mobile device from the selected mobile device manufacturer over the selected time period, and who migrated to any new mobile device; and
dividing value R_within by value R_away.

12. The method of claim 10, wherein the metric representative of the performance of the mobile device manufacturer is a manufacturer attraction index and consists in:
calculating value R_to as the total number of returning subscribers who migrated to a new mobile device from the selected mobile device manufacturer over the selected time period;
calculating value N_using as the total number of new subscribers who own a mobile device from the selected mobile device manufacturer over the selected time period;
calculating value R_away as the total number of returning subscribers who owned a mobile device from the selected mobile device Manufacturer over the selected time period, and who migrated to any new mobile device;
calculating value R_any as the total number of returning subscribers who migrated to any new mobile device over the selected time period;
calculating N_total as the total number of new subscribers over the selected time period; and
dividing (value R_to plus value N_using minus value R_away) by (value R_any plus value N_total).

13. The method of claim 10, wherein the metric representative of the performance of the mobile device manufacturer is a model attraction index of a selected model of mobile device from the selected manufacturer, and consists in:
calculating value R_to as the total number of returning subscribers who migrated to a new mobile device of the selected model over the selected time period;
calculating value N_using as the total number of new subscribers who own a mobile device of the selected model over the selected time period;
calculating value R_away as the total number of returning subscribers who owned a mobile device of the selected model over the selected time period, and who migrated to any new mobile device;
calculating value R_any as the total number of returning subscribers who migrated to any new mobile device over the selected time period;
calculating N_total as the total number of new subscribers over the selected time period; and
dividing (value R_to plus value N_using minus value R_away) by (value R_any plus value N_total).

14. The method of claim 13, wherein each subscriber record comprises a mobile device model identifier.

15. The method of claim 1, wherein at least one collecting entity:
captures in real time IP packets from a mobile IP traffic on the mobile operator network,
extracts relevant parameters from said captured IP packets, and transmits said parameters to a processing unit.

16. The method of claim 15, wherein the processing unit further processes the parameters for updating the database of subscriber records representative of mobile devices used on the mobile operator network.

17. The method of claim 16, wherein the parameters include an IMSI (International Mobile Subscriber Identity) or an MSISDN (Mobile Subscriber Integrated Services Digital Network Number) representing the unique identifier of a subscriber, and an IMEI (International Mobile Equipment Identity) representing the mobile device manufacturer identifier.

18. A system for evaluating a mobile device manufacturer performance, the system comprising:
a database for storing subscriber records representative of mobile devices used on a mobile operator network;
a processing unit:
for updating said database,
for extracting information from the subscriber records in the database in relation to a selected mobile device manufacturer and a selected time period, and
for processing said information to calculate a metric representative of a performance of said selected mobile device manufacturer over said selected time period;
wherein each subscriber record comprises at least a unique identifier of a subscriber, a mobile device manufacturer identifier, and a timestamp.

19. The system of claim 18, wherein the metric representative of the performance of the mobile device manufacturer is a manufacturer loyalty index.

20. The system of claim 19, wherein the manufacturer loyalty index consists in:
calculating value A as the total number of subscribers who owned a mobile device from the selected mobile device manufacturer over the selected time period, and who upgraded to a new mobile device;
calculating value B as the total number of subscribers who owned a mobile device from the selected mobile device manufacturer over the selected time period, and who upgraded to a new mobile device from the selected mobile device manufacturer; and
dividing value B by value A.

21. The system of claim 20, wherein the total number of subscribers who owned a mobile device from the selected mobile device manufacturer is calculated for a selected model or group of models within the portfolio of models of mobile devices manufactured by the selected mobile device manufacturer.

22. The system of claim 21, wherein each subscriber record comprises a mobile device model identifier.

23. The system of claim 18, wherein the metric representative of the performance of the mobile device manufacturer is a manufacturer attraction index.

24. The system of claim 23, wherein the manufacturer attraction index consists in:
calculating value A as the total number of subscribers who owned a mobile device from the selected mobile device manufacturer over the selected time period, and who upgraded to a new mobile device;
calculating value B as the total number of subscribers who owned a mobile device from the selected mobile device manufacturer over the selected time period, and who upgraded to a new mobile device from the selected mobile device Manufacturer;
calculating value C as the total number of subscribers who owned a mobile device from the selected mobile device manufacturer over the selected time period, and who upgraded to a new mobile device from a mobile device manufacturer different from the selected mobile device manufacturer; and
dividing (value B minus value C) by value A.

25. The system of claim 24, wherein the total number of subscribers who owned a mobile device from the selected mobile device manufacturer is calculated for a selected model or group of models within the portfolio of models of mobile devices manufactured by the selected mobile device manufacturer.

26. The system of claim 25, wherein each subscriber record comprises a mobile device model identifier.

27. The system of claim 18, wherein each subscriber has a status of either returning subscriber or new subscriber.

28. The system of claim 27, wherein the metric representative of the performance of the mobile device manufacturer is a manufacturer loyalty index and consists in:
calculating value R_within as the total number of returning subscribers who owned a mobile device from the selected mobile device manufacturer over the selected time period, and who migrated to a new mobile device from the selected mobile device manufacturer;
calculating value R_away as the total number of returning subscribers who owned a mobile device from the selected mobile device manufacturer over the selected time period, and who migrated to any new mobile device; and
dividing value R_within by value R_away.

29. The system of claim 27, wherein the metric representative of the performance of the mobile device manufacturer is a manufacturer attraction index and consists in:
calculating value R_to as the total number of returning subscribers who migrated to a new mobile device from the selected mobile device manufacturer over the selected time period;
calculating value N_using as the total number of new subscribers who own a mobile device from the selected mobile device manufacturer over the selected time period;
calculating value R_away as the total number of returning subscribers who owned a mobile device from the selected mobile device manufacturer over the selected time period, and who migrated to any new mobile device;
calculating value R_any as the total number of returning subscribers who migrated to any new mobile device over the selected time period;
calculating N_total as the total number of new subscribers over the selected time period; and
dividing (value R_to plus value N_using minus value R_away) by (value R_any plus value N_total).

30. The system of claim 27, wherein the metric representative of the performance of the mobile device manufacturer is a model attraction index of a selected model of mobile device from the selected manufacturer, and consists in:
calculating value R_to as the total number of returning subscribers who migrated to a new mobile device of the selected model over the selected time period;
calculating value N_using as the total number of new subscribers who own a mobile device of the selected model over the selected time period;
calculating value R_away as the total number of returning subscribers who owned a mobile device of the selected model over the selected time period, and who migrated to any new mobile device;
calculating value R_any as the total number of returning subscribers who migrated to any new mobile device over the selected time period;
calculating N_total as the total number of new subscribers over the selected time period; and
dividing (value R_to plus value N_using minus value R_away) by (value R_any plus value N_total).

31. The system of claim 30, wherein each subscriber record comprises a mobile device model identifier.

32. The system of claim 18, wherein at least one collecting entity:
captures in real time IP packets from a mobile IP traffic on the mobile operator network,
extracts relevant parameters from said captured IP packets, and
transmits said parameters to the processing unit.

33. The system of claim 32, wherein the processing unit further processes the parameters for updating the database of subscriber records representative of mobile devices used on the mobile operator network.

34. The system of claim 33, wherein the parameters include an IMSI (International Mobile Subscriber Identity) or an MSISDN (Mobile Subscriber Integrated Services Digital Network Number) representing the unique identifier of a subscriber, and an IMEI (International Mobile Equipment Identity) representing the mobile device manufacturer identifier.
